(19) United States
(12) Patent Application Publication
(10) Pub. No.: US 2024/0176990 A1
(43) Pub. Date: May 30, 2024

(54) Method and System for Graph-to-graph Prediction Based on Recurrent Neural Network

(71) Applicant: Yangtze Delta Region Institute (Huzhou), University of Electronic Science and Technology of China, Huzhou City (CN)

(72) Inventor: Guan WANG, Huzhou City (CN)

(21) Appl. No.: 18/479,474

(22) Filed: Oct. 2, 2023

(30) Foreign Application Priority Data
Nov. 29, 2022 (CN) 202211514646.2

(51) Int. Cl. G06N 3/0455; G06N 3/0985

(52) U.S. Cl. CPC G06N 3/0455; G06N 3/0985

(57) ABSTRACT

The present disclosure discloses a method and system for graph-to-graph prediction based on recurrent neural networks. The method includes: representing a graph structure as a sequence; based on the sequentialization representation of the graph structure, constructing a deep neural network model for graph-to-graph prediction, wherein both input and output of the deep neural network model are graph structures; the deep neural network model includes an Encoder and a Decoder, wherein, in the Encoder, employing encNodeRNN and encEdgeRNN in combination to encode an input graph, and the Decoder decodes based on an encoding vector obtained from the Encoder, thereby obtaining a corresponding predicted graph and realizing the graph-to-graph prediction.

### CROSS-REFERENCE TO RELATED APPLICATIONS

This application claims priority under 35 U.S.C. § 119(a) to Chinese Patent Application No. 202211514646.2, filed on Nov. 29, 2022, which is hereby incorporated by reference herein in its entirety for all purposes.

### TECHNICAL FIELD

The present disclosure relates to the field of machine learning technologies, and more particularly, to a method and system for graph-to-graph prediction based on a recurrent neural network.

### BACKGROUND

Currently, many objects in the objective world can be represented as graph structures, such as molecular structures, social networks, and transportation networks, etc. Existing graph-oriented machine learning algorithms mainly focus on graph classification and graph regression problems, where the input is a graph structure and the output is a numerical value. In contrast, graph structures are rarely considered as the output of such algorithms. The process of graph-to-graph prediction has many practical applications, such as the maximum clique prediction problem and the minimum spanning tree problem in algorithms, traffic network prediction based on road networks, and the prediction of brain functional graph structures, among others.

However, the learning process for graph-to-graph prediction is challenging. Unlike grid data (e.g., images, character sequences, etc.), nodes in a graph lack sequential and positional information. This leads to the inability to directly apply models from the fields of image and sequence processing, such as U-Net for image segmentation, to graph-to-graph learning models.

Some efforts have been made in the design of graph-to-graph models. Some of these efforts focus on variational autoencoders for molecular structures to generate molecular structures. Others focus on the design of graph autoencoders, but only design models that act on a single large graph, aiming to predict the connections between nodes within the graph. No universally applicable graph-to-graph prediction model has been proposed to solve general graph-to-graph prediction problems.

From the above analysis, the existing technology suffer from the following problems and shortcomings:
(1) Due to the lack of sequential and positional information in graph nodes, models from the fields of image and sequence processing cannot be directly applied to graph-to-graph learning models.
(2) The existing technology has only designed models that act on a single large graph and has not proposed a universally applicable graph-to-graph prediction model, thus failing to solve general graph-to-graph prediction problems.

### SUMMARY

In view of the problems existing in the prior art, the present disclosure provides a method and system for graph-to-graph prediction based on a recurrent neural network.

The object of the present disclosure is implemented through various embodiments of a graph-to-graph prediction method described herein. In some embodiments, the graph-to-graph prediction method comprises: representing a graph structure as a sequence; based on a sequentialization representation of the graph structure, constructing a deep neural network model for the graph-to-graph prediction, wherein both input and output of the deep neural network model are graph structures; the deep neural network model including an Encoder and a Decoder, wherein, in the Encoder, employing encNodeRNN and encEdgeRNN in combination to encode an input graph, and in the Decoder, decoding through the Decoder based on an encoding vector obtained from the Encoder, thereby obtaining a corresponding prediction graph and realizing the graph-to-graph prediction.

Generally, the graph-to-graph prediction method includes the following steps:
step one: performing the sequentialization representation of the graph structure;
step two: constructing a network model based on the sequentialization representation of the graph structure;
step three: performing the graph-to-graph prediction using the constructed network model.

In some embodiments, the sequentialization representation of the graph structure in step one includes: data to be processed is a set of undirected graph data G={V, E}, where V represents a set of all nodes in the graph, and E represents a set of all edges between all nodes; denoting A as an adjacency matrix of G, the graph G is represented as a sequence of adjacency vectors {X₁, X₂, . . . , Xₙ}, where Xᵢ=(A_{i,i-1}, A_{i,i-2}, . . . , A_{i,1}) encodes a connection relationship between node vᵢ and its previous nodes {vᵢ₋₁, vᵢ₋₂, . . . , v₁}. Based on the sequentialization representation of the graph structure, the graph G is converted into a nested sequence.

In step two, the deep neural network model constructed based on the sequentialization representation of the graph structure includes an Encoder and a Decoder. The Encoder is used to extract high-level semantic information from the input graph, representing the graph as two-dimensional sequence information and using a recurrent neural network for encoding, wherein graph information is encoded by two layers of recurrent neural networks, which include encEdgeRNN for encoding edge information and encNodeRNN for encoding node information. The encEdgeRNN sequentially reads elements from X_{i,1} to X_{i,i-1} in Xᵢ, denoted as g_{edge}; using GRU, g_{edge} generates a series of hidden state sequences (h_{i,1}^{edge}, h_{i,2}^{edge}, . . . , h_{i,i-1}^{edge}), where h_{i,1}^{edge} is taken as the encoding of the sequence from X_{i,1} to X_{i,i-1}, denoted as χᵢ, and then is input into the encNodeRNN. The encNodeRNN encodes all the encoding sequences (χ₁, χ₂, . . . , χₙ) generated by encEdgeRNN, thereby generating a final encoding of graph G, denoted as C.

Further, after the input graph G is encoded to obtain C, the decoder decodes C according to a specific task to obtain a corresponding output graph.

The encoder defines a probability distribution p(Y), where Y=(Y₀, Y₁, . . . , Yₘ₋₁) is an adjacency vector sequence obtained by the decoder; p(Y) is decomposed into a product of a series of conditional distributions:

p(Y)=Πᵢ₌₀^{m}p(Yᵢ|Y₀,Y₁, . . . ,Yᵢ₋₁,C);
where m represents the number of nodes in the prediction graph to be generated, and C is the graph encoding obtained by the encoder. Simplifying p(Yᵢ|Y₀, Y₁, . . . , Yᵢ₋₁,C) as P(Yᵢ|Y_{<i},C), then P(Yᵢ|Y_{<i},C) is decomposed into:

p(Yᵢ|Y_{<i},C)=Πₖ₌₀ⁱ⁻¹p(Y_{i,k}|Y_{i,<k},c;Y_{<i},C);
where c is the encoding generated when predicting Y_{i,k}.

Through two cascading RNNs, the decNodeRNN is responsible for transferring the information of the generated graph from the i−1th node to the ith node, thereby generating a new node; while the decEdgeRNN is responsible for generating the edges between the ith node and the previous nodes in an autoregressive manner.

In some embodiments, a definition of a loss function of the model in step two includes:
for a sequentialization representation X of a given input graph and a corresponding true output graph Y, in the model M, a loss value between the predicted edge and the true edge between the ith node and the jth node is [symbol] _{i,j}=−(1−pᵢⱼ^{t})^{γ} log(p_{i,j}^{t}), where pᵢⱼ^{t} represents a likelihood of correct prediction, and γ is a hyperparameter for adjustment, set as γ=2.

A final model prediction loss function is [symbol] (X),Y)= [symbol] where [symbol] varies depending on the actual problem being solved; for a maximum clique computation problem, ∀a∈ [symbol] ,Xₐ=1.

Another object of the present disclosure is to provide a graph-to-graph prediction system for implementing the aforementioned graph-to-graph prediction method, wherein, the graph-to-graph prediction system includes:
a graph structure sequentialization representation module for representing a graph structure as a sequence;
a deep neural network model construction module for constructing a deep neural network model for graph-to-graph prediction, wherein both input and output of the deep neural network model are graph structures;
a graph structure encoding module for encoding an input graph at the encoder of the deep neural network model using encNodeRNN and encEdgeRNN in combination;
an encoding vector decoding module for decoding based on an encoding vector obtained from the encoder to obtain a corresponding predicted graph, thereby realizing the graph-to-graph prediction.

Another object of the present disclosure is to provide a computing device, and the computing device includes a memory and a processor, wherein the memory stores a computer program which, when executed by the processor, causes the processor to perform the steps of the aforementioned graph-to-graph prediction method.

Another object of the present disclosure is to provide a computer-readable storage medium for storing a computer program which, when executed by a processor, causes the processor to perform the steps of the aforementioned graph-to-graph prediction method.

Another object of the present disclosure is to provide an information data processing terminal, wherein, the information data processing terminal is used to implement the aforementioned graph-to-graph prediction system.

In conjunction with the above exemplary embodiments and the technical problems to be solved, the advantages and positive effects possessed by the technical solution claimed in the present disclosure are as follows:

Firstly, in view of the technical problems existing in the prior art and the difficulty in solving these problems, a detailed and profound analysis is conducted closely in conjunction with the technical solution to be protected by the present disclosure, as well as the results and data obtained during the research and development process. Specifically, the technical solution of the present disclosure on how it solves the technical problems and the creative technical effects brought about after solving the problems are described as follows:

The graph-to-graph prediction method based on the recurrent neural network provided by the present disclosure first represents a graph structure as a sequence. Based on this sequentialization representation, a deep neural network model for graph-to-graph prediction is developed, where both the input and output of the model are graph structures.

Secondly, viewing the technical solution as a whole or from the product perspective, the technical effects and advantages possessed by the technical solution to be protected by the present disclosure are described as follows:

The present disclosure proposes a model for graph-to-graph prediction, where the input is a graph and the output is also a graph, thereby solving the technical problem that existing methods cannot effectively and scientifically predict graph-to-graph models.

Thirdly, as creative supplementary evidence for the claims of the present disclosure, the technical solution also manifests in the following important aspects:

The technical solution of the present disclosure fills a technical gap in both domestic and international industries:

Currently, the focus in the field of graph processing is mainly on graph classification and regression problems, i.e., focusing on numerical outputs, with little consideration for graph structure outputs. The present disclosure is the first to address the generalized graph-to-graph prediction problem and proposes the first graph-to-graph prediction model, where both the input and output are graph structures. The effectiveness of the proposed model is demonstrated through maximum clique prediction and graph reconstruction problems.

### BRIEF DESCRIPTION OF THE DRAWINGS

To more clearly illustrate the technical solution of the embodiments of the present disclosure, a brief introduction will be provided below for the accompanying drawings needed in the embodiments of the present disclosure. It is evident that the accompanying drawings described below are merely some embodiments of the present disclosure, and that those skilled in the art can obtain other accompanying drawings based on these drawings without exerting creative effort.

FIG. 1 is a flowchart of the graph-to-graph prediction method according to an embodiment of the present disclosure;

FIG. 2 is a flowchart of the sequentialization representation method for a graph with 4 nodes according to an embodiment of the present disclosure;

FIG. 3 is a model framework diagram for graph-to-graph learning according to an embodiment of the present disclosure;

FIG. 4 is a schematic diagram of the visualization results for maximum clique prediction according to an embodiment of the present disclosure; and

FIG. 5 is a schematic diagram of the visualization results for graph reconstruction prediction according to an embodiment of the present disclosure.

### DETAILED DESCRIPTION

To clarify the objectives, technical solutions, and advantages of the present disclosure, the following detailed description is provided in conjunction with specific embodiments. It should be appreciated that the specific embodiments described herein are merely illustrative of the present disclosure and are not intended to limit the scope of the present disclosure.

Addressing the problems existing in the prior art, the present disclosure provides a method and system for graph-to-graph prediction based on a recurrent neural network. A detailed description of the disclosure is provided below with reference to the accompanying drawings.

To enable those skilled in the art to fully understand how the present disclosure is specifically implemented, this section serves as an explanatory example that elaborates on the technical solutions claimed in the application.

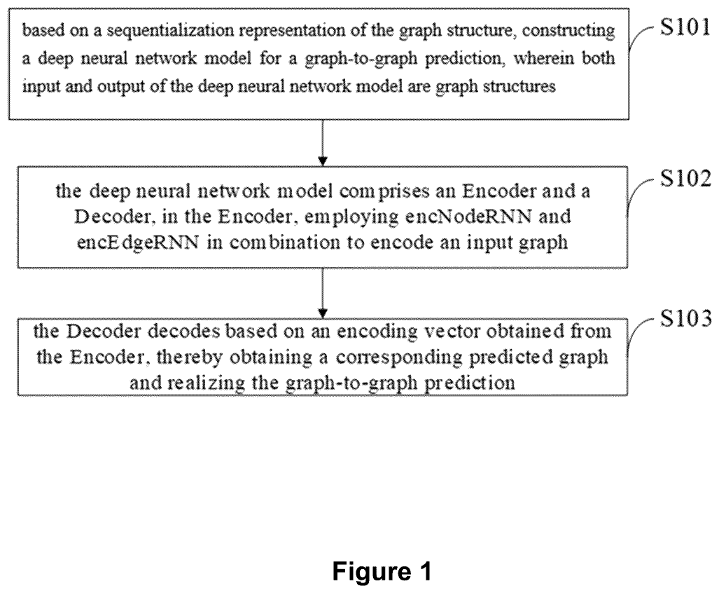

As shown in FIG. 1, the graph-to-graph prediction method provided in the embodiments of the present disclosure comprises the following steps:
S101: based on the sequentialization representation of the graph structure, constructing a deep neural network model for graph-to-graph prediction, wherein both input and output of the deep neural network model are graph structures.
S102: the deep neural network model including an Encoder and a Decoder, and in the Encoder, employing encNodeRNN and encEdgeRNN in combination to encode an input graph.
S103: decoding through the Decoder based on an encoding vector obtained from the Encoder, thereby obtaining a corresponding predicted graph and realizing the graph-to-graph prediction.

As a preferred embodiment, the graph-to-graph prediction method includes the following steps:

### 1. Sequentialization Representation of Graphs

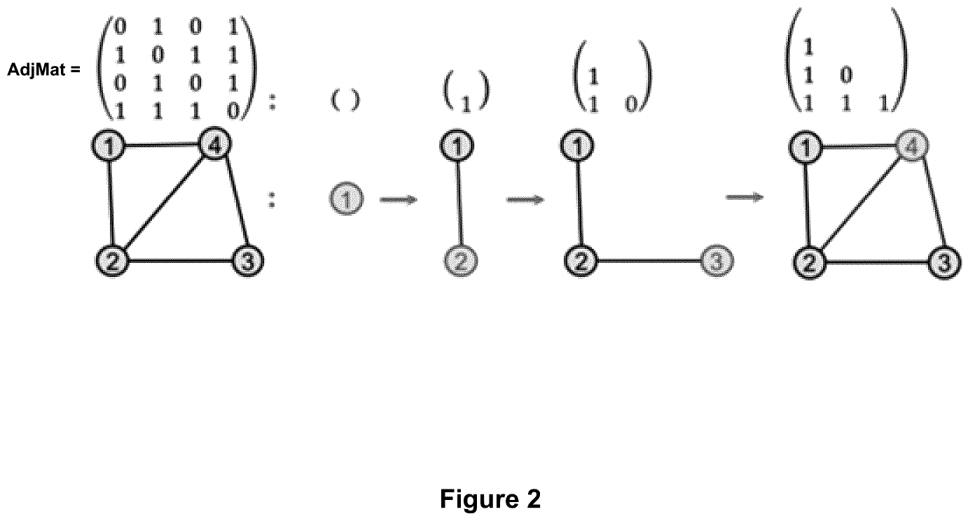

The data processed by the present disclosure consists of a set of undirected graph data G={V,E}, where V represents a set of all nodes in the graph, and E represents a set of all edges between the nodes. The adjacency matrix of graph G is denoted as A, and the graph G is represented as a sequence of adjacency vectors {X₁, X₂, . . . , Xₙ}, where Xᵢ=(A_{i,i-1}, A_{i,i-2}, . . . , A_{i,1}) encodes the connection relationship between node vᵢ and its preceding nodes {vᵢ₋₁, vᵢ₋₂, . . . , v₁}. Based on this representation, the graph G can be converted into a nested sequence, as shown in FIG. 2.

### 2. Network Model Structure

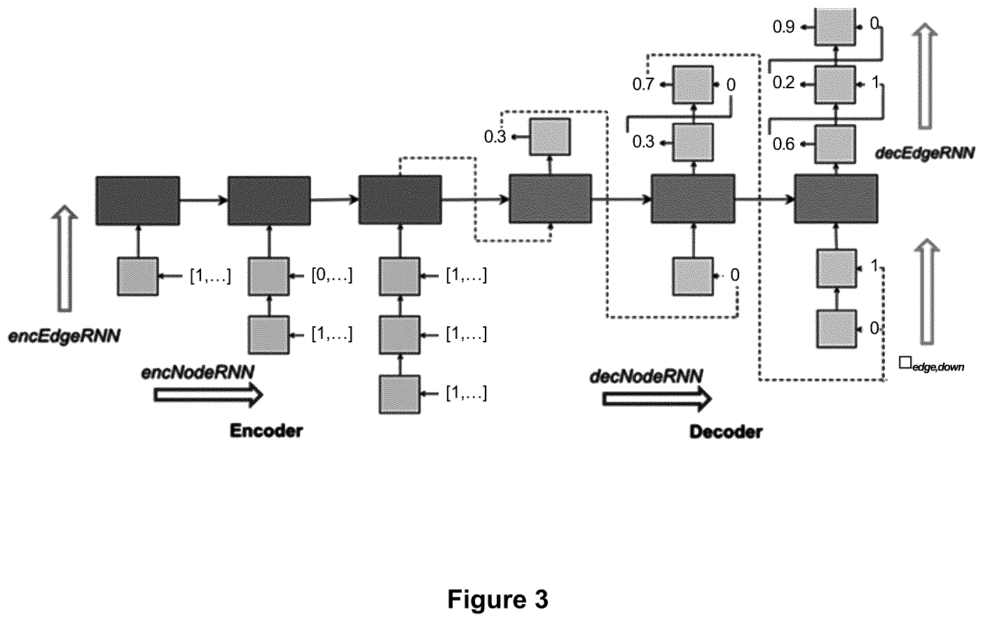

Based on the sequentialization representation of graphs, the present disclosure has developed a model for graph-to-graph prediction. The overall framework of the model is shown in FIG. 3.

This model is built upon the recurrent neural network and specifically comprises an encoder and a decoder.

### 2.1 Encoder

The encoder mainly extracts high-level semantic information from the input graph. The graph is represented as a two-dimensional sequence, and is encoded by a Recurrent Neural Network (RNN). The graph information is encoded by two layers of RNNs, specifically encEdgeRNN for encoding edge information and encNodeRNN for encoding node information. The encEdgeRNN reads elements in Xᵢ from X_{i,1} to X_{i,i-1} in sequence, and the encEdgeRNN is denoted as g_{edge}. the present disclosure utilizes a GRU (Gated Recurrent Unit), and g_{edge} produces a series of hidden state sequences (h_{i,1}^{edge}, h_{i,2}^{edge}, . . . , h_{i,i-1}^{edge}). The present disclosure takes h_{i,1}^{edge} as the encoding of the sequence from X_{i,1} to X_{i,i-1}, denoted as χᵢ, and inputs it into the encNodeRNN. The encNodeRNN further encodes all the encoding sequences (χ₁, χ₂, . . . , χₙ) produced by the encEdgeRNN, thereby generating the final encoding of graph G, denoted as C. The specific process is shown in the encoder part in FIG. 3.

### 2.2 Decoder

After the input graph G is encoded into C, the decoder decodes C based on the specific task to generate the corresponding output graph. The workflow of the decoder is explained by using the maximum clique algorithm as an example herein. In this example, the decoder needs to determine which nodes and edges in the graph form the maximum clique. Mathematically, the encoder can define a probability distribution p(Y), where Y=(Y₀, Y₁, . . . , Yₘ₋₁) is the adjacency vector sequence obtained by the decoder. The probability distribution p(Y) can be decomposed into a product of a series of conditional distributions:

p(Y)=Πᵢ₌₀^{m}p(Yᵢ|Y₀,Y₁, . . . ,Yᵢ₋₁,C)
where, m represents the number of nodes in the prediction graph to be generated, and C is the graph encoding obtained from the encoder. p(Yᵢ|Y₀, Y₁, . . . , Yᵢ₋₁, C) can be abbreviated as P(Yᵢ|Y_{<i}, C), then P(Yᵢ|Y_{<i}, C) can also be further decomposed as:

p(Yᵢ|Y_{<i},C)=Πₖ₌₀ⁱ⁻¹p(Y_{i,k}|Y_{i,<i},c;Y_{<i},C)
where, c is the encoding generated when predicting Y_{i,k}.

The above two formulas are implemented by using two cascading RNNs, which respectively correspond to decNodeRNN and decEdgeRNN in FIG. 3. The decNodeRNN can transfer the information of the generated graph from the i−1th node to the ith node, thereby generating a new node, and the decEdgeRNN can generate the edges between the ith node and its preceding nodes in an autoregressive manner, as shown in the decoder part in FIG. 3.

### 2.3 Definition of the Model's Loss Function

For a sequentialization representation X of a given input graph and a corresponding true output graph Y, in the model M, a loss value between the predicted edge and the true edge between the ith node and the jth node is l_{i,j}=−(1−pᵢⱼ^{t})^{γ} log(p_{i,j}^{t}), where pᵢⱼ^{t} represents a likelihood of correct prediction, and γ is a hyperparameter for adjustment. In an embodiment, γ may be equal to 2.

A final model prediction loss function is [symbol] (X),Y)= [symbol] where [symbol] varies depending on the actual problem being solved, for example, for a maximum clique computation problem, ∀a∈ [symbol] , Xₐ=1.

According to various embodiments of the present disclosure, the graph-to-graph prediction system includes:
a graph structure sequentialization representation module for representing a graph structure as a sequence;
a deep neural network model construction module for constructing a deep neural network model for graph-to-graph prediction, wherein both input and output of the deep neural network model are graph structures;
a graph structure encoding module for encoding an input graph at the encoder of the deep neural network model by using encNodeRNN and encEdgeRNN in combination;
an encoding vector decoding module for decoding based on an encoding vector obtained from the encoder to obtain a corresponding prediction graph, thereby realizing the graph-to-graph prediction.

To demonstrate the inventiveness and technical value of the technical solution claimed in the present application, this section provides specific examples of products or related technologies.

Many problems can be mathematically formulated as a graph-to-graph prediction problem, such as maximum clique prediction, minimum spanning tree computation, traffic network prediction based on road networks, and functional network prediction based on brain neural networks. Therefore, developing a model for graph-to-graph prediction has significant application prospects.

The embodiments of the present disclosure have achieved some positive effects during its research and development or usage process, and indeed has significant advantages compared to existing technologies. The following content describes these advantages with reference to data and charts obtained during the testing process.

### 1. Maximum Clique Prediction

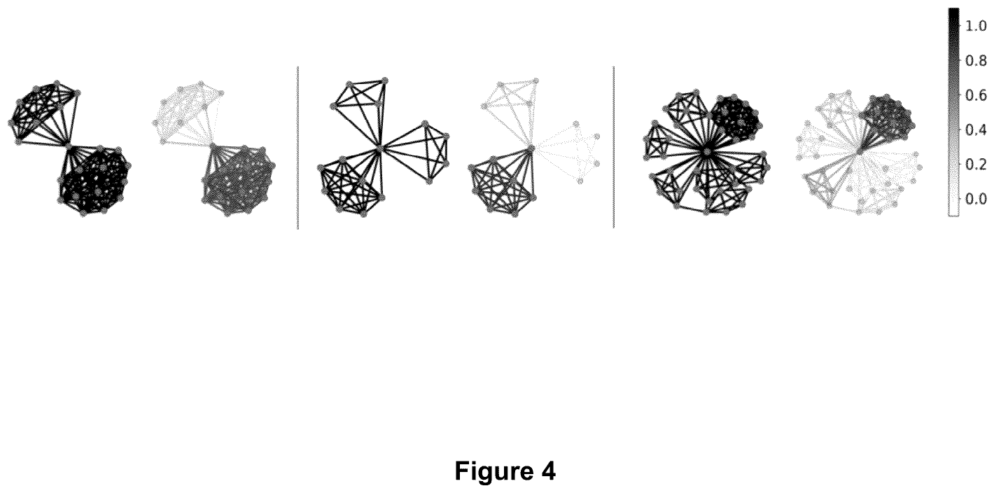

The maximum clique of a graph G refers to the largest complete subgraph of the graph G. The input is the original graph G, and the output is the largest complete subgraph G*. The embodiments of the present disclosure have been tested on publicly available datasets using Accuracy rate and Edge IOU (Intersection Over Union) as evaluation metrics, and has achieved good results. FIG. 4 and Table 1 show some visual results and quantitative analysis. Preliminary results indicate that the algorithm of the present disclosure can effectively perform maximum clique prediction and has achieved better results compared to related work.

TABLE 1
Qualitative analysis of maximum clique prediction on three public datasets

| | DBLP_v1 dataset | | IMDB-MULTI dataset | | Deezer_ego_nets dataset | |
|---|---|---|---|---|---|---|
| | Accuracy | Edge | Accuracy | Edge | Accuracy | Edge |
| Model | rate | IOU | rate | IOU | rate | IOU |
| MLP | 85.0 | 93.8 | 61.0 | 85.7 | 33.2 | 66.7 |
| GRU w/o Attn | 85.9 | 95.4 | 54.3 | 79.8 | 42.8 | 69.7 |
| GRU w/Attn | >3 days | | Memory Overflow | | 46.5 | 76.7 |
| Graph2Graph | 95.5 | 97.4 | 82.3 | 92.5 | 58.5 | 81.8 |

### 2. Graph Autoencoder

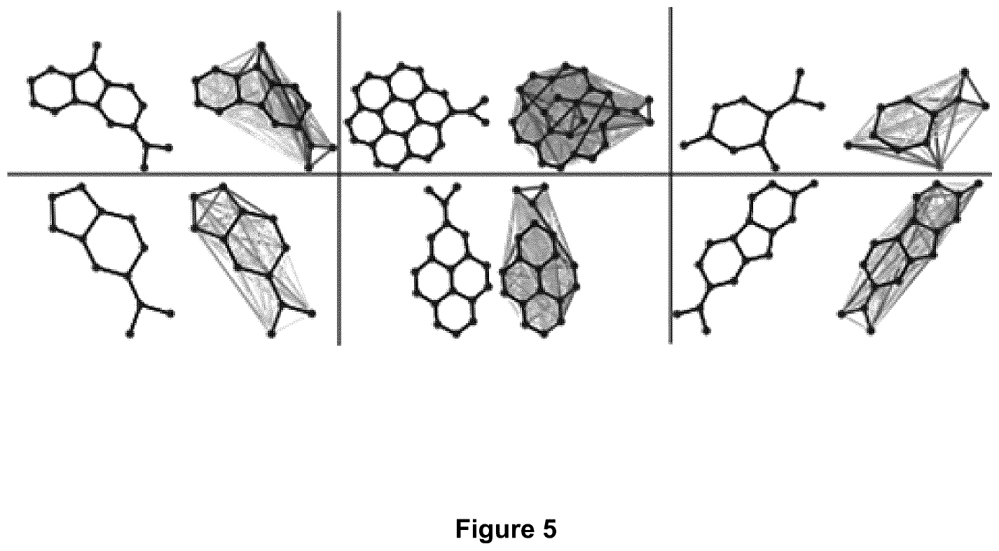

A graph autoencoder refers to a model where both the input and output are graph G, i.e., the graph reconstruction process. Similar to the experiment of the maximum clique, the embodiments of the present disclosure have also been tested on publicly available datasets using Accuracy rate and Edge IOU as evaluation metrics. As shown in FIG. 5 and Table 2, the results indicate that the model of the present disclosure can produce meaningful reconstructed graph structures, outperforming related models in terms of graph reconstruction.

TABLE 2
Qualitative analysis of graph reconstruction prediction on three public datasets

| | DBLP_v1 dataset | | IMDB-MULTI dataset | | MUTAG dataset | |
|---|---|---|---|---|---|---|
| | Accuracy | Edge | Accuracy | Edge | Accuracy | Edge |
| Model | rate | IOU | rate | IOU | rate | IOU |
| MLP | 79.8 | 98.2 | 72.6 | 93.7 | 0.00 | 85.3 |
| GRU w/o Attn | 67.5 | 94.6 | 45.0 | 69.4 | 0.00 | 76.9 |
| GRU w/Attn | >3 days | | Memory Overflow | | 0.00 | 84.4 |
| GraphVAE | >3 days | | >3 days | | 0.00 | 86.4 |
| Graph2Graph | 83.5 | 98.8 | 78.0 | 95.2 | 7.8 | 89.1 |

It should be noted that the embodiments of the present disclosure can be implemented through hardware, software, or a combination of both. The hardware part can be implemented using dedicated logic; the software part can be stored in a memory and executed by an appropriate instruction execution system, such as a microprocessor or specially designed hardware. Those skilled in the art will understand that the above-described devices and methods can be implemented using computer-executable instructions and/or included in processor control code, such as code provided on carrier media like disks, CDs or DVDs, programmable memory like ROM (Read-Only Memory), or data carriers like optical or electronic signals. The devices and modules of the present disclosure can be implemented by hardware circuits like VLSI (Very-Large-Scale Integration) or gate arrays, semiconductor devices like logic chips or transistors, or programmable hardware devices like FPGAs (Field-Programmable Gate Arrays) or PLDs (Programmable Logic Devices), or can be implemented by software executed by various types of processors, or can be implemented by a combination of hardware circuits and software, such as firmware.

The above merely describes specific embodiments of the present disclosure, which is not intended to limit the scope of protection of the present disclosure. Any modifications, equivalent variations or substitutions, and improvements made within the spirit and principle of the present disclosure by those skilled in the art according to the disclosed technical scope should be included in the protection scope of the present disclosure.

What is claimed is:

1. A graph-to-graph prediction method, comprising:
representing a graph structure as a sequence;
based on a sequentialization representation of the graph structure, constructing a deep neural network model for a graph-to-graph prediction, wherein both input and output of the deep neural network model are graph structures;
the deep neural network model comprising an Encoder and a Decoder, wherein, in the Encoder, employing encNodeRNN and encEdgeRNN in combination to encode an input graph, and the Decoder decodes based on an encoding vector obtained from the Encoder, thereby obtaining a corresponding prediction graph and realizing the graph-to-graph prediction.

2. The graph-to-graph prediction method of claim 1, comprising the following steps:
step one: performing the sequentialization representation of the graph structure;
step two: constructing a network model based on the sequentialization representation of the graph structure;
step three: performing the graph-to-graph prediction using a constructed network model.

3. The graph-to-graph prediction method of claim 2, wherein, in step one, the sequentialization representation of the graph structure comprises: data to be processed is a set of undirected graph data G={V,E}, where V represents a set of all nodes in the graph, and E represents a set of all edges between all nodes; denoting A as an adjacency matrix of G, the graph G is represented as a sequence of adjacency vectors {X₁, X₂, . . . , Xₙ}, where Xᵢ=(A_{i,i-1}, A_{i,i-2}, . . . , A_{i,1}) encodes a connection relationship between node vᵢ and its previous nodes {vᵢ₋₁, vᵢ₋₂, . . . , v₁}; based on the sequentialization representation of the graph structure, the graph G is converted into a nested sequence.

4. The graph-to-graph prediction method of claim 2, wherein, in step two, the deep neural network model constructed based on the sequentialization representation of the graph structure comprises the Encoder and the Decoder,
wherein the Encoder is used to extract high-level semantic information from the input graph, representing the input graph as two-dimensional sequence information and using a recurrent neural network for encoding, wherein graph information is encoded by two layers of recurrent neural networks, which comprise the encEdgeRNN for encoding edge information and the encNodeRNN for encoding node information,
wherein the encEdgeRNN sequentially reads elements from X_{i,1} to X_{i,i-1} in Xᵢ, denoted as g_{edge}; using GRU, g_{edge} generates a series of hidden state sequences (h_{i,1}^{edge}, h_{i,2}^{edge}, . . . , h_{i,i-1}^{edge}), where h_{i,1}^{edge} is taken as the encoding of the sequence from X_{i,1} to X_{i,i-1}, denoted as χᵢ, and is input into encNodeRNN, and
wherein the encNodeRNN encodes all the encoding sequences (χ₁, χ₂, . . . , χₙ) generated by the encEdgeRNN, thereby generating a final encoding of the graph G, denoted as C.

5. The graph-to-graph prediction method of claim 4, wherein, after the input graph G is encoded to obtain C, the Decoder decodes C according to a specific task to obtain a corresponding output graph;
the Encoder defines a probability distribution p(Y), where Y=(Y₀, Y₁, . . . , Yₘ₋₁) is an adjacency vector sequence obtained by the Decoder; p(Y) is decomposed into a product of a series of conditional distributions:
p(Y)=Πᵢ₌₀^{m}p(Yᵢ|Y₀,Y₁, . . . ,Yᵢ₋₁,C);
where m represents the number of nodes in the prediction graph to be generated, and C is the graph encoding obtained by the Encoder; simplifying p(Yᵢ|Y₀, Y₁, . . . , Yᵢ₋₁, C) as P(Yᵢ|Y_{<i}, C), then P(Yᵢ|Y_{<i}, C) is decomposed into:
p(Yᵢ|Y_{<i},C)=Πₖ₌₀ⁱ⁻¹p(Y_{i,k}|Y_{i,<k},c;Y_{<i},C);
where c is the encoding generated when predicting Y_{i,k};
using two cascading RNNs, the decNodeRNN is responsible for transferring the information of the generated graph from the i−1th node to the ith node, thereby generating a new node; while the decEdgeRNN is responsible for generating the edges between the ith node and its previous nodes in an autoregressive manner.

6. The graph-to-graph prediction method of claim 2, wherein, a definition of a loss function of the model in step two comprises:
for a sequentialization representation X of a given input graph and a corresponding true output graph Y, in the model M, a loss value between the predicted edge and the true edge between the ith node and the jth node is l_{i,j}=−(1−pᵢⱼ^{t})^{γ} log(p_{i,j}^{t}), where pᵢⱼ^{t} represents a likelihood of correct prediction, and γ is a hyperparameter for adjustment, set as γ=2;
a final model prediction loss function is [symbol] (X),Y)= [symbol] where [symbol] varies depending on the actual problem being solved, and for a maximum clique computation problem, ∀a∈ [symbol] , Xₐ=1.

7. A graph-to-graph prediction system for implementing the graph-to-graph prediction method of claim 1, comprising:
a graph structure sequentialization representation module for representing a graph structure as a sequence;
a deep neural network model construction module for constructing a deep neural network model for a graph-to-graph prediction, wherein both input and output of the deep neural network model are graph structures;
a graph structure encoding module for encoding an input graph at the encoder of the deep neural network model using encNodeRNN and encEdgeRNN in combination;
an encoding vector decoding module for decoding based on an encoding vector obtained from the Encoder to obtain a corresponding predicted graph, thereby realizing the graph-to-graph prediction.

8. A computing device, wherein, the computing device comprises a memory and a processor, and the memory stores a computer program which, when executed by the processor, causes the processor to perform the steps of the graph-to-graph prediction method of claim 1.

9. A computer-readable storage medium storing a computer program which, when executed by a processor, causes the processor to perform the steps of the graph-to-graph prediction method of claim 1.

10. An information data processing terminal, wherein, the information data processing terminal is used to implement the graph-to-graph prediction system of claim 7.
